(19) United States
(12) Patent Application Publication
(10) Pub. No.: US 2017/0154466 A1
(43) Pub. Date: Jun. 1, 2017

(54) INTERACTIVELY AUGMENTED REALITY ENABLE SYSTEM

(71) Applicants: Inventec (Pudong) Technology Corporation, Shanghai (CN); INVENTEC CORPORATION, TAIPEI CITY (TW)

(72) Inventor: Chin-Yi WU, TAIPEI CITY (TW)

(21) Appl. No.: 15/139,313

(22) Filed: Apr. 26, 2016

(30) Foreign Application Priority Data
Nov. 26, 2015 (CN) 201510843251.0

(51) Int. Cl. G06T 19/00; H04L 29/08; G06F 1/16

(52) U.S. Cl. CPC G06T 19/006; G06F 1/163; H04L 67/10

(57) ABSTRACT

Interactively augmented reality enable system includes a wearable interactive display apparatus, and a cloud server. The wearable interactive display apparatus includes a display portion having a visual-field direction, a positioning portion, a transmit/receive module, and a computing module. The positioning portion generates a positioning signal transmitted by the transmit/receive module and a visual-field direction signal. The cloud server receives the positioning signal from the transmit/receive module, and generates a virtual circumstance signal merged from the virtual landscape signal, the virtual event signal, and the virtual objects signal. The computing module receives the virtual circumstance signal through the transmit/receive module, and then, the computing module generates an image signal to display on the display portion.

### RELATED APPLICATIONS

This application claims priority to Chinese Application Serial Number 201510843251.0, filed Nov. 26, 2015, which is herein incorporated by reference.

### BACKGROUND

Field of Invention

The present disclosure relates to an augmented reality enable system. More particularly, the present disclosure relates to an interactively augmented reality enable system.

Description of Related Art

Conventional augmented reality applications usually merges a live view of real world with elements augmented by computer-generated sensory input, such as video, sound, image or image of global positioning system (GPS), which would demonstrate an user experience more approach to reality comparing to general virtual reality. In addition, applications of augmented reality system may be further applied to a view of reality modified by a computing apparatus, which may lead to an enhancement for a user's perception of reality, and provide additional information aside from the surrounding circumstance. For example, an augmented contents may be applied in real-time and in visual images with environmental elements, such as game statistic and summaries, during a match. Furthermore, as the proliferation of mobile devices, such as smart phones, is developed more advance, the information about the surrounding environment may be displayed on a mobile devices with additional augmented contents, such as virtual objects generated to overlay on objects of real world, or information about the surrounding circumstance being displayed.

However, applications of augmented reality applied on online games, comparatively speaking, are much more inadequate, and most of the applications, applied in games and peripherals with fixed network service for fixed point applicant, are not necessarily worked with the global positioning system. Besides, performance of online games on smart phone, applied with augmented reality, is restricted by hardware performance of smart phone, which can only provide restricted operation modes and visual display. Consequently, the available augmented reality system, as described above, apparently exists with inconvenience and defect, which needs further improvement. To deal with aforesaid problem, practitioners of ordinary skill in the art have striven to attain a solution, still lacks a suitable solution to be developed. Therefore, to deal with aforesaid problem effectively is an important subject of research and development, and also a desired improvement in the art.

### SUMMARY

The present disclosure provides a interactively augmented reality enable system. The interactively augmented reality enable system includes a wearable interactive display apparatus, and a cloud server. The wearable interactive display apparatus includes a display portion, a positioning portion, a transmit/receive module, and a computing module. The display portion has a visual-field direction. The positioning portion can generate a positioning signal and a visual-field direction signal, respectively, based on a location of the wearable interactive display apparatus and the visual-field direction of the display portion. The transmit/receive module can transmit the positioning signal. The cloud server includes a mapping module, a management module, and an objects module. The mapping module can receive the positioning signal from the transmit/receive module, and generate a virtual landscape signal based on the positioning signal. The management module can generate a virtual event signal based on the virtual landscape signal, and event and time axis data. The objects module can generate a virtual objects signal based on the virtual landscape signal, the event and time axis data, and a virtual objects data. The virtual landscape signal, the virtual event signal, and the virtual objects signal can be merged to generate a virtual circumstance signal. The computing module receives the virtual circumstance signal through the transmit/receive module, subsequently, the computing module can generate an image signal based on the visual-field direction signal, and the virtual circumstance signal. The display portion can display an image based on the image signal.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic block diagram of an interactively augmented reality enable system according to an embodiment of the present disclosure.

FIG. 2 is a schematic block diagram of an interactively augmented reality enable system according to another embodiment of the present disclosure.

FIG. 3 to FIG. 5 are simplified schematic drawings of an interactively augmented reality enable system utilized in real-world according to some embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

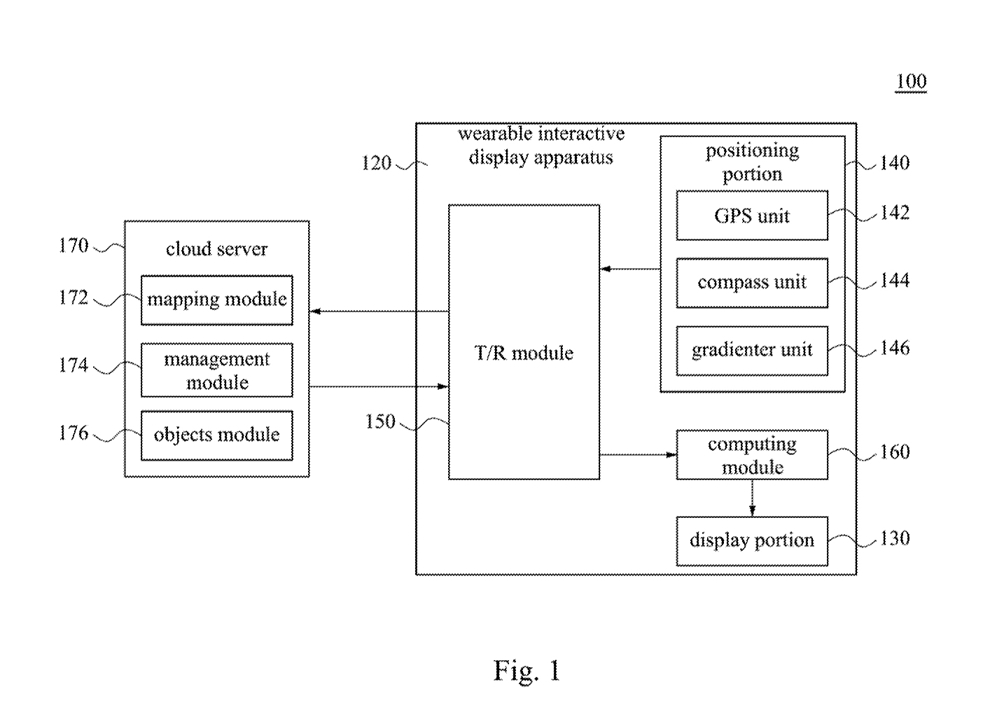

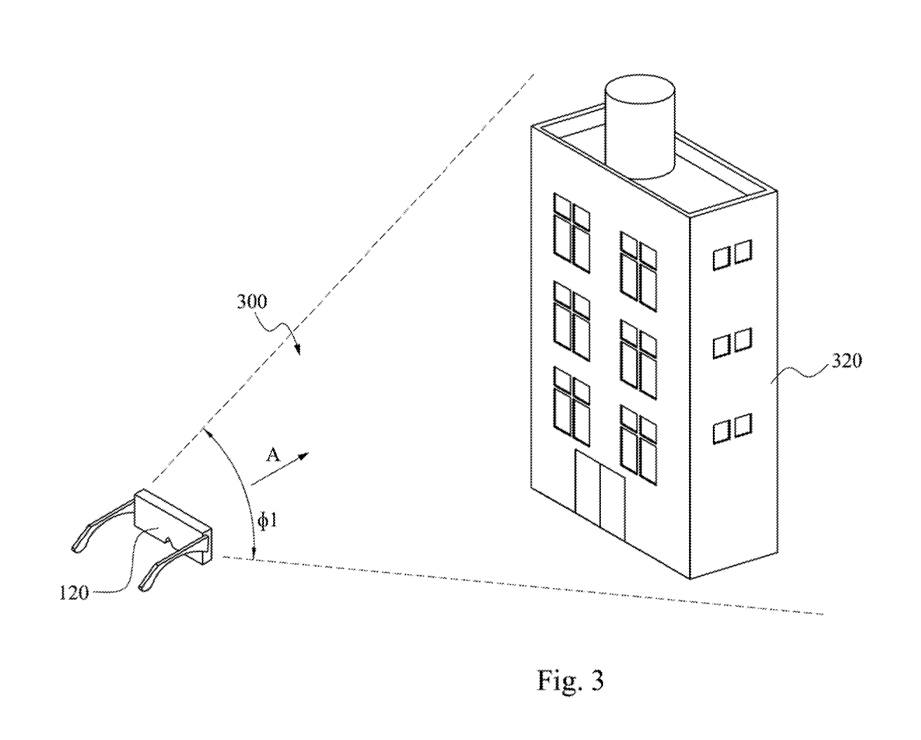

FIG. 1 illustrates a schematic block diagram of an interactively augmented reality enable system 100, described organization and connection relation among the components of the interactively augmented reality enable system 100, according to an embodiment of the present disclosure. As shown in FIG. 1, interactively augmented reality enable system 100 includes a wearable interactive display apparatus 120 and a cloud server 170. In some embodiments, the wearable interactive display apparatus 120 can be wore on an user's head, and part of the wearable interactive display apparatus 120 may be placed in front of an user's eyes to occupy at least a part of a visual-field of the user. The wearable interactive display apparatus 120 includes a display portion 130, a positioning portion 140, a transmit/receive module 150, and a computing module 160. The display portion 130 has a visual-field direction, as shown in FIG. 3. In some embodiments, while the wearable interactive display apparatus 120 is wore by an user, the display portion 130 is placed and occupied a front side of an user's visual field, and the display portion 130 may define a visual-field direction along an orientation of the user's eyes. The positioning portion 140 can generate a positioning signal and a visual-field direction signal, respectively, based on a location of the wearable interactive display apparatus 120 and the visual-field direction of the display portion 130. The transmit/receive module 150 can transmit the positioning signal to the cloud server 170. In some embodiments, the transmit/receive module 150 can transmit the positioning signal to the cloud server 170 through local area networks (LANs), wide area networks (WANs), overlay networks, software-defined networks or other suitable network transmission method.

Further, the cloud server 170 can generate and transmit a virtual circumstance signal to the wearable interactive display apparatus 120, according to the positioning signal received from the transmit/receive module 150. The cloud server 170 includes a mapping module 172, a management module 174, and an objects module 176. The mapping module 172 may receive the positioning signal from the transmit/receive module 150, and generate a virtual landscape signal based on the positioning signal. In some embodiments, the virtual landscape signal may include original landscapes, original landscapes being digitized or virtual landscape data of the cloud server 170 used to replace or overlay the original landscapes. The management module 174 can generate a virtual event signal based on the virtual landscape signal, and an event and time axis data. In some embodiments, the management module 174 can be an event and time management module. The virtual event signal can be alterably generated according to various virtual landscape signal and the event and time axis data. Furthermore, the management module 174 may update or modify digital contents of the virtual landscape data based on the virtual event signal, so as to influence the virtual landscape signal being generated in the meantime. The objects module 176 may generate a corresponded virtual objects signal based on the virtual landscape signal, the event and time axis data, and a virtual objects data. In some embodiments, the virtual objects signal may include an objects information, such as object statues, object positions or quantity of objects etc., in which the virtual objects signal may further update or modify the digital contents of the virtual landscape data, and progress the event and axis data to various stages, or more. The virtual circumstance signal includes the virtual landscape signal, the virtual event signal, and the virtual objects signal, the display contents of the virtual circumstance signal would be described later. After the computing module 160 receives the virtual circumstance signal through the transmit/receive module 150, subsequently, the computing module 160 can generate an image signal, retrieved or cropped from the virtual circumstance signal, based on the visual-field direction of the display portion 130 and the visual-field direction signal generated according to the visual-field direction. In some embodiments, the computing module 160 may be a central processing unit (CPU), system on chip (SOC), graphic processing unit (GPU) or other suitable computing module for processing image signal. It should be understood that, the computing module 160, described herein, may represent designated resources being capable to physically and/or logically process software, firmware or hardware, and configured to proceed computing of image processing. The display portion 130 can display an image based on the image signal. In some embodiments, the display portion 130 can be a liquid crystal display or other suitable display devices.

The interactively augmented reality enable system 100 can create digital contents of a virtual world through linking the wearable interactive display apparatus 120 with the cloud server 170, and display image or live-view through the display portion 130, for the user to perceive. Therefore, the interactively augmented reality enable system 100 may further extend the contents of augmented reality to merge with landscapes in real world. That is, the mapping module 172, the management module 174 and the objects module 176 of the cloud server 170 can generate digital contents of the various virtual landscape signals, the virtual event signal, and the virtual objects signal, and the digital contents are merged as a virtual circumstance signal to be overlaid on landscape of real world. Subsequently, the computing module 160 crops or retrieves a part of the virtual circumstance signal based on the visual-field direction signal generated by the positioning portion 140, to generate the image signal, which would be displayed on the display portion 130. An user can view a virtual world collectively composed by the virtual landscape, the virtual event, and the virtual objects through the image displayed on the display portion 130. Therefore, the image created by the interactively augmented reality enable system 100 can make an impact on user's perception comparing to the real world, a different experiences can be experienced to an augmented reality world. Furthermore, the virtual landscape and the virtual objects can be updated or modified based on the time-dependent virtual event, which may further improve the diversity of an augmented reality world.

It should be noted that, in some embodiments, the transmit/receive module 150 may include one or more communication interfaces, including but not limited to the present disclosure. The communication interfaces may include different physical interfaces, such as a wired or a wireless local area network interface, a wireless broadband network interface, as well as, a personal area network (PAN) or other suitable communication interface, to connect the transmit/receive module 150, the positioning portion, the computing module 160 to the cloud server 170. It should be understood that, aspect of the transmit/receive module 150, could be adjusted to actual demand by those skilled in the art, without departed from the scope or the spirits of the present disclosure. That is to say, prerequisite of the transmit/receive module 150 is to receive signals from the positioning portion 140 and the cloud server 170, and transmit a readable or applicable signal to the cloud server 170 and the computing module 160.

In some embodiments, the positioning portion 140 may include a GPS (global positioning system) unit 142. The GPS unit 142 may position a coordinate of the wearable interactive display apparatus based on the location of the wearable interactive display apparatus, then the positioning signal are generated according to the information of the coordinate, for example, such as 15 minutes 47 seconds east longitude 122 degrees, 23 degrees north latitude 45 minutes 11 seconds. In some embodiments, the positioning portion 140 may further includes a compass unit 144. In some embodiments, the compass unit 144 may be an electronic compass, a gyroscope, or other suitable electronic positioning unit. The compass unit 144 can detect a visual-field orientation of the display portion 130 based on the visual-field direction of the display portion 130, for example, such as north, northeast etc.

In some embodiments, the positioning portion 140 may further includes a gradienter 146. In some embodiments, the gradienter 146 may be an electronic gradienter, a gyroscope, or other suitable electronic unit for measuring the elevation relative to the horizontal. The gradienter 146 may compute a visual-field elevation of the display portion 130 with respect to the horizontal plane based on the visual-field direction, for example, such as 30 degrees of elevation level or 47 degrees of elevation level. In some embodiments, the visual-field direction signal may include the visual-field orientation and the visual-field elevation of the display portion 130, the visual-field direction signal is configured to determine which part of the virtual circumstance signal being croped. The croped virtual circumstance signal is adopted to generate a corresponded image signal for displaying on the display portion 130, which would be described as following.

In some embodiments, the virtual circumstance signal is generated in the manners that assigning the center of the virtual circumstance signal at the coordinate corresponding to the positioning signal of the wearable interactive display apparatus 120, and generating the virtual circumstance signal digital contents originated from the center. The computing module 160 based on a three-dimensional visual field extending along the visual-field direction from the display portion 130, to crop or retrieve a part of the virtual circumstance signal within the three-dimensional visual field, as for generating the corresponded image signal. The image displayed by the display portion 130 is generated from the part of the virtual circumstance signal corresponded to the three-dimensional visual field. In some embodiments, the image displayed by the display portion is based on the part of the virtual circumstance signal within the three-dimensional visual field.

Owing to the virtual circumstance signal generated by the cloud server 170 is a three-dimensional image signal, and corresponded with spatial locations in real world. The cloud server 170 may include map data of real world and the virtual landscape signal, the virtual event signal, and the virtual objects signal generated corresponded with the map data. However, the virtual circumstance signal, transmitted to the wearable interactive display apparatus 120, is generated by the cloud server 170 in the manners that, partially croping the map data, the virtual landscape signal, the virtual event signal, and the virtual objects signal, within a visual range of the wearable interactive display apparatus 120 for being merged into the virtual circumstance signal, in which the visual range may be determined from that assigning the visual range centered at the coordinate corresponding with the positioning signal of the wearable interactive display apparatus 120, and substantially covering all orientations and all elevations within a visual-field radius. As a consequence, the virtual circumstance signal, described herein, comparing to the virtual circumstance signal generated by fully-croped, may have less data to store or be transmitted between the cloud server 170 and the wearable interactive display apparatus 120. A reaction time for cropping the virtual circumstance signal through the computing module 160 of the wearable interactive display apparatus 120 may also be reduced while less data needs to be computed. A reaction speed of the wearable interactive display apparatus 120 may be more timely, benefited from the reaction time, such that the wearable interactive display apparatus 120 can create a virtual world much closer to the real world by improving the feeling of reality with short reaction time.

In some embodiments, a map data mapping module 172 may merge with a virtual landscape data, to generate the virtual landscape signal. The cloud server 170 may update the virtual landscape data based on the virtual event signal. Therefore, digital contents of the virtual landscape data may be correspondingly modified with different virtual events occurred. For example, while a breaking out of fire setup in the virtual event signal is occurred at the time, the breaking out of fire generated by the virtual event signal may overlay the corresponded virtual landscape data, to update the breaking out of fire on the virtual landscape data to set a fire, such that a breaking out of fire is occurred on the virtual landscape.

In some embodiments, the virtual objects data may include one or more object image, one or more object statue, one or more object position, and one or more object elevation with respect to the horizontal plane, in which one of the object statues, one of the object positions, and one of the object elevations are collectively corresponded to one of the object images. The cloud server 170 may update the event and time axis data based on the virtual object data. Therefore, digital contents of the event and time axis data may be correspondingly modified with different virtual objects data. For example, while a breaking out of fire setup in the virtual event signal is occurred on a virtual landscape, an user use a virtual fire extinguisher among the virtual objects data to put out the breaking out of fire, subsequently, the breaking out of fire generated by the virtual event signal would be updated to cease. The ceasing of the breaking out of fire may be updated on the virtual landscape data, such that a breaking out of fire on the virtual landscape is put out.

Owing to the cloud server 170 is configured to update the virtual landscape data based on the virtual event signal, update the event and time axis data based on the virtual object data, and the generation of the virtual objects data is influenced by the virtual landscape data and the event and time axis data, so that the virtual landscape data, the event and time axis data, and the virtual objects data are interlinked to each other, and able to modified each other. Therefore, modified one of the virtual landscape data, the event and time axis data, and the virtual objects data may also jointly update the rest to be modified, which may provide an user an experience, much approach to the real world, for an user.

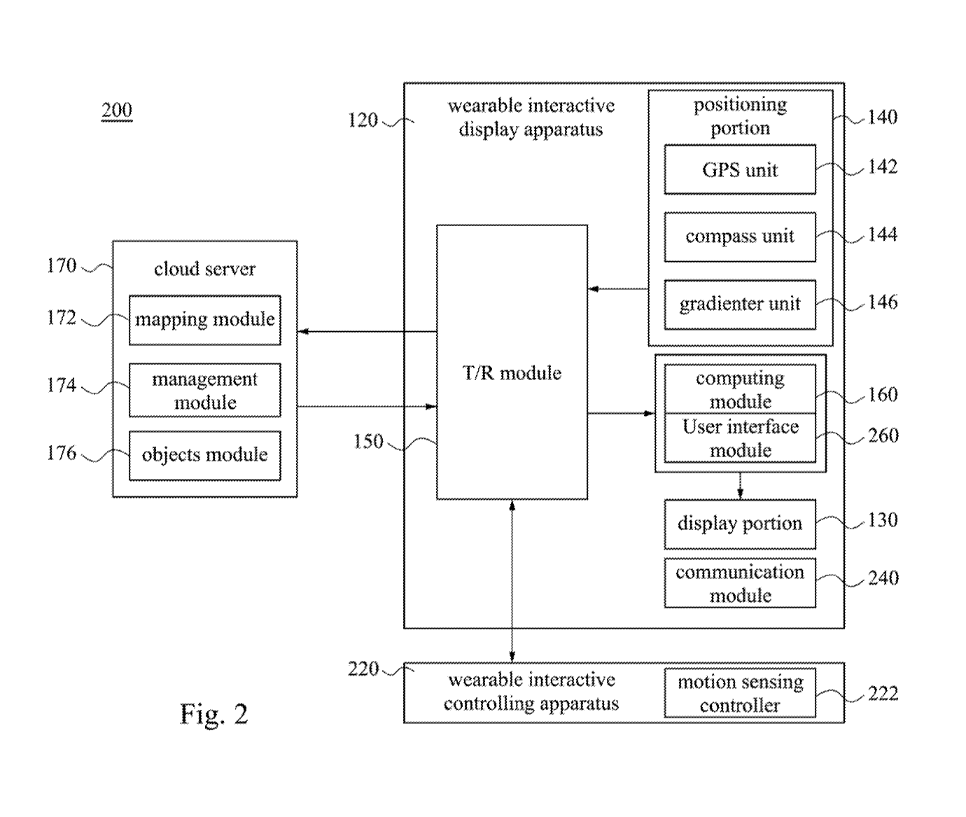

FIG. 2 illustrates a schematic block diagram of an interactively augmented reality enable system 200 according to another embodiment of the present disclosure. The interactively augmented reality enable system 200 may further include a communication module 240, comparing to the interactively augmented reality enable system 100, including but not limited to the present disclosure. The communication module 240 may be configured to link the wearable interactive display apparatus 120 to another wearable interactive display apparatus 120. Therefore, users can be teamed up, and communicate with each other through the communication module 240. Furthermore, different users can undergo or experience a same augmented reality together. In some embodiment, the communication module 240 may enable users communicated with each others through voice, image or other suitable communication method.

In some embodiments, the interactively augmented reality enable system 200 may further include a wearable interactive controlling apparatus 220. The wearable interactive controlling apparatus 220 is linked to the wearable interactive display apparatus 120. In some embodiments, the wearable interactive controlling apparatus 220 may be linked to the wearable interactive display apparatus 120 through local area networks (LANs), wide area networks (WANs), overlay networks, software-defined networks or other suitable network transmission method. In some embodiments, the wearable interactive controlling apparatus 220 may be linked to the wearable interactive display apparatus 120 through wired or wireless. The wearable interactive controlling apparatus 220 includes a motion sensing controller 222. The motion sensing controller 222 may detect a motion signal, and transmit a controlling signal, corresponded to the motion signal, to the wearable interactive display apparatus 120. In some embodiments, the wearable interactive controlling apparatus 220 can be wore on a hand of an user, and the user can actuate or drive the motion sensing controller 222 to generate a corresponded motion signal through detecting a gesture or movement of the hand. In some embodiments, an user may actuate or drive the motion sensing controller 222 to generate corresponded motion signals through detecting different gestures or various movements of a hand.

It should be noted that, the wearable interactive controlling apparatus 220 and the motion sensing controller 222, described herein, is only for exemplary, and not intended to limit the present disclosure. In some embodiments, the wearable interactive controlling apparatus 220 can be wore on a hand or other part of a body. It should be understood that, aspect of the wearable interactive controlling apparatus 220 and the motion sensing controller 222, could be adjusted to actual demand by those skilled in the art, without departed from the scope or the spirits of the present disclosure. That is to say, prerequisite of the wearable interactive controlling apparatus 220 is to detect a motion of an user through the motion sensing controller 222, to actuate or drive the wearable interactive controlling apparatus 220, and a controlling signal is generated based on a motion signal, and transmitted to the wearable interactive display apparatus 120.

In some embodiments, the wearable interactive display apparatus 120 may further include a user interface module 260. The user interface module 260 can generate a menu signal. In some embodiments, the menu signal may include one or more select operators. In some embodiments, the menu signal may be merged with the image signal, and displayed on the image of the display portion. In the meantime, the wearable interactive display apparatus 120 can choose among the select operators of the menu signal based on the controlling signal generated by a motion signal.

In some embodiments, the computing module 160 of the wearable interactive display apparatus 120 may enable to merge the motion signal of the wearable interactive controlling apparatus 220, and the virtual circumstance signal, to generate the image signal. In some embodiments, the wearable interactive controlling apparatus 220 can update or modified the virtual circumstance signal through the motion signal. Therefore, an user can interact with the virtual objects signal of the virtual circumstance signal through the wearable interactive controlling apparatus 220, and update the virtual objects signal to modify or update the virtual event signal and the virtual landscape signal.

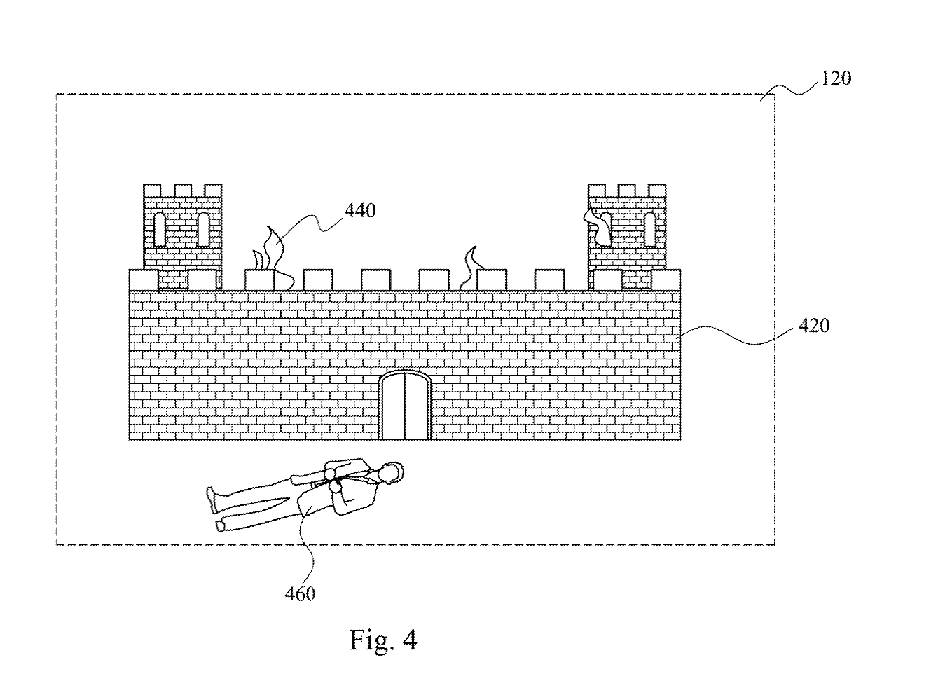

FIG. 3 is simplified schematic drawing of a wearable interactive display apparatus 120 utilized in real-world, in which the wearable interactive display apparatus 120 of the interactively augmented reality enable system 100 or the interactively augmented reality enable system 200 may be adopted, according to some embodiments of the present disclosure. FIG. 4 is simplified schematic drawing of an image displayed on the display portion 130 for an user, while the wearable interactive display apparatus 120 of the interactively augmented reality enable system 100 is utilized in real-world, according to some embodiments of the present disclosure. As shown in FIG. 3, an user may face the real world through the wearable interactive display apparatus 120 of the interactively augmented reality enable system 100 or the interactively augmented reality enable system 200. As a consequence, the positioning portion 140 of the wearable interactive display apparatus 120 may generate a positioning signal based on a location of the wearable interactive display apparatus. The positioning signal, described herein, for example, may represent a corresponded coordinate for the location the wearable interactive display apparatus generated by the global positioning system unit 142. In the meanwhile, the positioning portion 140 may generate a visual-field direction signal based on a visual-field direction A of the display portion 130, and expanded a predetermined solid angle Φ1 along the visual-field direction A in real world, to crop a three-dimensional space 300. As shown in FIG. 3, a targeted landscape 320 is located within the three-dimensional space 300 in real world.

As shown in FIG. 4, the cloud server 170 constructs a corresponded virtual circumstance signal originated at a positioning signal of the wearable interactive display apparatus 120 generated by the positioning portion 140. The virtual circumstance signal may include a virtual landscape signal corresponded to the location of the wearable interactive display apparatus 120 based on the positioning signal, a corresponded virtual event signal generated from the virtual landscape signal and event and time axis data, and a corresponded virtual objects signal generated from the virtual landscape signal, event and time axis data, and a virtual objects data. A part of the virtual circumstance signal is cropped by the computing module 160, based on the three-dimensional space 300 in FIG. 3, to generate a image signal. The image signal is substantially same as the part of the virtual circumstance signal croped by the three-dimensional space 300 in FIG. 3. The image signal is transmitted to the display portion 130 to produce an image. The image may include a virtual landscape 420, a virtual event 440, and a virtual objects 460, substantially respectively corresponded at least part of the virtual landscape signal, the virtual event signal, and the virtual objects signal.

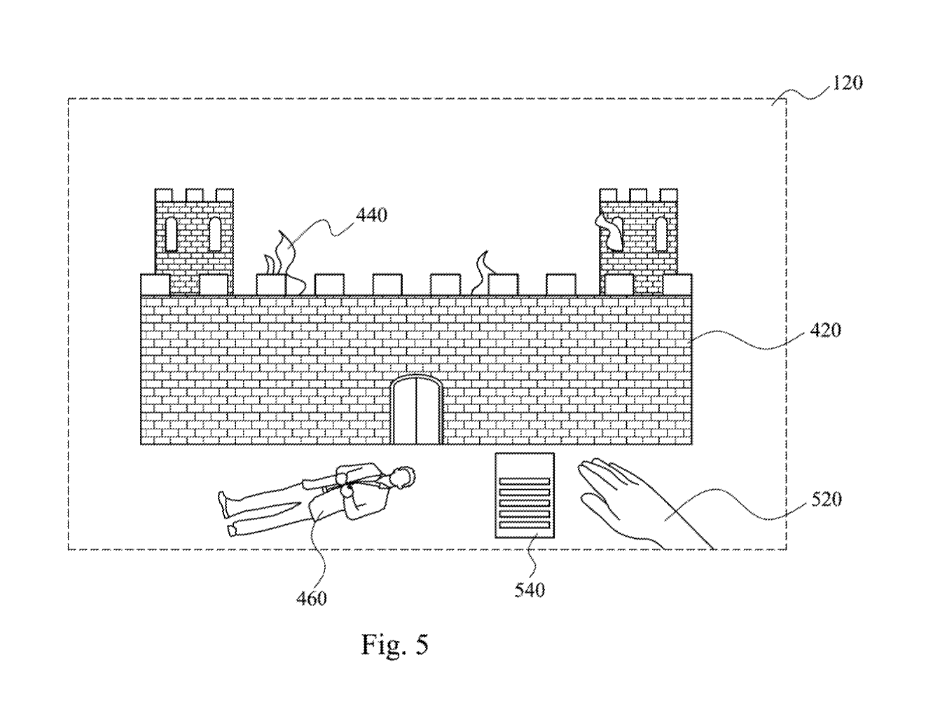

FIG. 4 is simplified schematic drawing of an image displayed on the display portion 130 for an user, while the wearable interactive display apparatus 120 of the interactively augmented reality enable system 200 is utilized in real-world, according to some embodiments of the present disclosure. As shown in FIG. 5, the computing module 160 of the interactively augmented reality enable system 200 crops a part of the virtual circumstance signal, based on the three-dimensional space 300 in FIG. 3, to generate a image signal, as well as shown in FIG. 4. The image signal is substantially same as the part of the virtual circumstance signal croped by the three-dimensional space 300 in FIG. 3. The image signal is transmitted to the display portion 130 to produce an image. The image may include a virtual landscape 420, a virtual event 440, and a virtual objects 460, substantially respectively corresponded at least part of the virtual landscape signal, the virtual event signal, and the virtual objects signal. In addition, the image displayed on the display portion 130 of the interactively augmented reality enable system 200 may further include a virtual controlling apparatus 520 corresponded with the wearable interactive controlling apparatus 220, and select operators 540 generated by a menu signal of an user interface module 260, merged with the image signal. An user may interact to a virtual object 460 through the wearable interactive controlling apparatus 220, to update or modify the virtual landscape signal, the virtual event signal, and the virtual objects signal. In the meanwhile, the user can also interact with the select operators 540 generated by a menu signal through the wearable interactive controlling apparatus 220.

Summarized from the above, the present disclosure provides an a wearable interactive display apparatus, and a cloud server. The wearable interactive display apparatus includes a display portion, a positioning portion, a transmit/receive module, and a computing module. The display portion has a visual-field direction. The positioning portion can generate a positioning signal and a visual-field direction signal, respectively, based on a location of the wearable interactive display apparatus and the visual-field direction of the display portion. The transmit/receive module can transmit the positioning signal. The cloud server includes a mapping module, a management module, and an objects module. The mapping module can receive the positioning signal from the transmit/receive module, and generate a virtual landscape signal based on the positioning signal. The management module can generate a virtual event signal based on the virtual landscape signal, and event and time axis data. The objects module can generate a virtual objects signal based on the virtual landscape signal, the event and time axis data, and a virtual objects data. The virtual landscape signal, the virtual event signal, and the virtual objects signal can be merged to generate a virtual circumstance signal. The computing module receives the virtual circumstance signal through the transmit/receive module, subsequently, the computing module can generate an image signal based on the visual-field direction signal, and the virtual circumstance signal. The display portion can display an image based on the image signal.

Although some embodiments of the present disclosure and their advantages have been described in detail, it should be understood that various changes, substitutions, and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, fabricate, composition of matter, means, methods, and steps described in the specification. As one of ordinary skill in the art will readily appreciate from the disclosure of the present disclosure, processes, machines, fabricate, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, fabricate, compositions of matter, means, methods, or steps.

What is claimed is:

1. An interactively augmented reality enable system, comprising:
a wearable interactive display apparatus, comprising:
a display portion, having a visual-field direction;
a positioning portion, configured to generate a positioning signal and a visual-field direction signal, respectively, based on a location of the wearable interactive display apparatus and the visual-field direction of the display portion;
a transmit/receive module, configured to transmit the positioning signal; and
a computing module; and
a cloud server, comprising:
a mapping module, configured to receive the positioning signal from the transmit/receive module, and generate a virtual landscape signal based on the positioning signal;
a management module, configured to generate a virtual event signal based on the virtual landscape signal, and an event and time axis data; and
an objects module, configured to generate a virtual objects signal based on the virtual landscape signal, the event and time axis data, and a virtual objects data,
wherein the virtual landscape signal, the virtual event signal, and the virtual objects signal are merged to generate a virtual circumstance signal,
wherein the computing module receives the virtual circumstance signal through the transmit/receive module, subsequently, the computing module is configured to generate an image signal based on the visual-field direction signal, and the virtual circumstance signal, and the display portion is configured to display an image based on the image signal.

2. The interactively augmented reality enable system of claim 1, wherein the positioning portion comprises:
a GPS (global positioning system) unit, configured to position a coordinate of the wearable interactive display apparatus based on the location of the wearable interactive display apparatus, and generate the positioning signal based on the coordinate.

3. The interactively augmented reality enable system of claim 1, wherein the positioning portion comprises:
a compass unit, configured to detect a visual-field orientation of the display portion based on the visual-field direction; and
a gradienter, configured to compute a visual-field elevation of the display portion with respect to the horizontal plane based on the visual-field direction,
wherein the visual-field direction signal comprises the visual-field orientation and the visual-field elevation.

4. The interactively augmented reality enable system of claim 1, wherein the virtual circumstance signal is generated on condition that the center of the virtual circumstance signal is assigned at the positioning signal of the wearable interactive display apparatus.

5. The interactively augmented reality enable system of claim 1, wherein the computing module is configured to generate a three-dimensional visual field extending along the visual-field direction from the display portion, and a part of the virtual circumstance signal within the three-dimensional visual field is croped by the computing module, to generate the image signal.

6. The interactively augmented reality enable system of claim 5, wherein the image displayed by the display portion is based on the part of the virtual circumstance signal within the three-dimensional visual field.

7. The interactively augmented reality enable system of claim 1, wherein a map data and a virtual landscape data are merged by the mapping module, to generate the virtual landscape signal, wherein the cloud server is configured to update the virtual landscape data based on the virtual event signal.

8. The interactively augmented reality enable system of claim 1, wherein the virtual objects data comprises one or more object images, one or more object statues, one or more object positions, and one or more object elevations with respect to the horizontal plane, wherein one of the object statues, one of the object positions, and one of the object elevations are collectively corresponded to one of the object images, wherein the cloud server is configured to update the event and time axis data based on the virtual objects data.

9. The interactively augmented reality enable system of claim 1, wherein the wearable interactive display apparatus further comprises a communication module, configured to link the wearable interactive display apparatus to another wearable interactive display apparatus.

10. The interactively augmented reality enable system of claim 1, further comprising a wearable interactive controlling apparatus, linked to the wearable interactive display apparatus, the wearable interactive controlling apparatus comprising:
a motion sensing controller, configured to detect a motion signal, and transmit a controlling signal, corresponded to the motion signal, to the wearable interactive display apparatus.

11. The interactively augmented reality enable system of claim 10, wherein the wearable interactive display apparatus further comprises:
a user interface module, configured to generate a menu signal, comprising one or more select operators, wherein the menu signal is merged with the image signal, and displayed on the image of the display portion, and the wearable interactive display apparatus is configured to choose among the select operators of the menu signal based on the controlling signal.

12. The interactively augmented reality enable system of claim 10, wherein the computing module of the wearable interactive display apparatus merges the motion signal and the virtual circumstance signal, to generate the image signal, and the wearable interactive controlling apparatus is configured to update the virtual circumstance signal through the motion signal.
